(19) United States
(12) Patent Application Publication
(10) Pub. No.: US 2022/0234753 A1
(43) Pub. Date: Jul. 28, 2022

(54) An Aerial Imaging System and Method

(71) Applicant: AEROMETREX PTY LTD, Glynde (AU)

(72) Inventor: David Byrne, Glynde (AU)

(21) Appl. No.: 17/612,739

(22) PCT Filed: May 22, 2020
(86) PCT No.: PCT/AU2020/050504

§ 371 Date: Nov. 19, 2021

(30) Foreign Application Priority Data
May 24, 2019 (AU) 2019901776

(51) Int. Cl. B64D 47/08; H04N 5/232; H04N 5/225; G01C 11/02; G06V 20/17; G06V 10/62; G06T 17/05; G06T 3/40; B64C 39/02

(52) U.S. Cl. CPC B64D 47/08; H04N 5/23238; H04N 5/2252; G01C 11/02; G06V 20/17; B64C 2201/141; G06T 17/05; G06T 3/4038; B64C 39/024; B64C 2201/127; G06V 10/62

(57) ABSTRACT

Described herein is an aerial imaging system (100) including a plurality of cameras (104-107) configured to be mounted in operable positions on an underside of an aerial vehicle (102). Each camera (104-107) is oriented at a respective angle in a direction transverse to a direction of flight of the aerial vehicle (102) such that the cameras image separate non-overlapping fields of view during image capture. Also described herein is a method (400) of performing aerial photogrammetry using the aerial imaging system (100).

### FIELD OF THE INVENTION

The present application relates to digital imaging and in particular to aerial imaging systems and methods.

Embodiments of the present invention are particularly adapted for a multi-camera photogrammetry imaging system mounted to an aerial vehicle and an associated method of performing aerial photogrammetry. However, it will be appreciated that the invention is applicable in broader contexts and other applications.

### BACKGROUND

Aerial imaging systems typically include one or more high resolution cameras mounted to aerial vehicles such as airplanes and unmanned aerial vehicles (UAVs). One important application of aerial imaging systems is photogrammetry, which involves forming a composite photographic image of a geographic area based on a number of individual images.

Existing aerial photogrammetry systems include one or more cameras mounted on an underside of an aerial vehicle and positioned to image the ground substantially vertically downwardly. Many single camera systems rely on the associated aerial vehicle to perform consecutive flight paths in which the imaging area of the single camera is overlapping. This requires increased flight time and therefore increased costs.

More advanced single camera systems utilize a sweeping camera which sweeps laterally to capture overlapping lateral images as the aerial vehicle moves in a forward direction. An example of this type of system is the A3 Edge, developed by Visionmap, a division of Rafael Advanced Defense Systems. This increases the amount of spatial coverage of each flight run and therefore reduces the flight time over more conventional single camera systems. However, each point of overlap in images is obtained from a very close location (the sweeping camera). This makes the subsequent image stitching process from image feature matching more difficult as intersecting rays of light are almost parallel. Furthermore, these sweeping systems are more complex in design and require specialist maintenance if technical issues arise. Specialist proprietary software is also required for processing the images to produce an aerial map.

Separately, multi-camera systems utilize multiple cameras mounted on an underside of an aerial vehicle which individually image separate fields of view. By way of example, some multi-camera systems include cameras that capture images both nadir and obliquely for the purpose of 3D modelling. However, these systems are less efficient as more flight runs are required to comprehensively image a geographical region.

Any discussion of the background art throughout the specification should in no way be considered as an admission that such art is widely known or forms part of common general knowledge in the field.

### SUMMARY OF THE INVENTION

In accordance with a first aspect of the present invention, there is provided an aerial imaging system including a plurality of cameras configured to be mounted in operable positions on an underside of an aerial vehicle, each camera being oriented at a respective angle in a direction transverse to a direction of flight of the aerial vehicle such that the cameras image separate non-overlapping fields of view during image capture.

In some embodiments, each of the cameras is oriented at off-nadir angles. In some embodiments, the system includes an even number of cameras. In some embodiments, the cameras are oriented at angles between 5 degrees and 25 degrees from nadir. In one embodiment, the system includes four cameras.

In some embodiments, the system includes an odd number of cameras. In some embodiments, one of the cameras is oriented nadir.

In accordance with a second aspect of the present invention, there is provided a method of performing aerial photogrammetry using an aerial imaging system having a plurality of cameras configured to be mounted in an operable position on an underside of an aerial vehicle and oriented such that, in operation, the cameras image separate non-overlapping fields of view, the method including the steps:
i. moving the aerial vehicle along a first imaging path and capturing a plurality of first temporal image sequences, each of the first temporal image sequences corresponding to a sequence of images captured from a respective one of the plurality of cameras and covering respective first spatially separated regions of an area being imaged;
ii. moving the aerial vehicle along a second imaging path and capturing a plurality of second temporal image sequences, each of the second temporal image sequences corresponding to a sequence of images captured from a respective one of the plurality of cameras and covering respective second spatially separated regions of the area being imaged;
wherein the second imaging path is defined such that the fields of view of each of the cameras partially overlap with at least one of the fields of view of a camera along the first imaging path thereby to provide partial overlap between the first and second spatially separated regions of the area being imaged.

In some embodiments, the first and second imaging paths are defined such that the first spatially separated regions partially overlap with the second spatially separated regions captured by the same camera.

In some embodiments, the second imaging path is substantially parallel or antiparallel to the first imaging path and shifted laterally relative to a direction of flight of the aerial vehicle.

In some embodiments, the overlap between the first and second spatially separated regions of the area being imaged is in the range of 5% to 50%. In one embodiment, the overlap between the first and second spatially separated regions of the area being imaged is 30%.

In some embodiments, the method includes the step of performing image processing on the images from the first and second temporal image sequences to generate an aerial map of the area being imaged.

In some embodiments, the first and second imaging paths correspond to consecutive runs of a flight path over the area being imaged. In other embodiments, the first and second imaging paths correspond to non-consecutive runs of a flight path over the area being imaged.

In some embodiments, the first and second imaging paths correspond to a same direction of travel of the aerial vehicle. In other embodiments, the first and second imaging paths correspond to an opposite direction of travel of the aerial vehicle.

In accordance with a third aspect of the present invention, there is provided a method of generating an aerial map of an area from the first and second temporal image sequences produced by the method of the second aspect, the method including the steps of:
i. determining the relative positions of the images in the first and second temporal image sequences; and
ii. stitching the images together based on common features identified in the partial overlap regions of the images to generate an aerial map of the area.

In accordance with a fourth aspect of the present invention, there is provided an aerial map of an area generated by a method according to the second aspect.

### BRIEF DESCRIPTION OF THE FIGURES

Example embodiments of the disclosure will now be described, by way of example only, with reference to the accompanying drawings in which:

FIG. 1 is a schematic view of an aerial imaging system mounted on an underside of an airplane, the aerial imaging system having four cameras;

FIG. 2 is a schematic front view of an airplane having an aerial imaging system shown in operation imaging a region of the ground;

FIG. 3 schematically illustrates four separate fields of views of four cameras of the aerial imaging system of FIGS. 1 and 2;

FIG. 4 is a flow chart illustrating the primary steps in an aerial photogrammetry process performed using the system of FIGS. 1 and 2;

FIG. 5 is a schematic plan view of a flight path having a plurality of substantially linear runs;

FIG. 6 is a schematic illustration of four temporal image sequences captured along a first run by the four cameras of the aerial imaging system of FIGS. 1 and 2;

FIG. 7 is a schematic illustration of four temporal image sequences captured along a second run by the four cameras of the aerial imaging system of FIGS. 1 and 2;

FIG. 8 is a schematic front view of the airplane of FIGS. 1 and 2 during two consecutive runs illustrating the overlapping fields of view of the cameras;

FIG. 9 schematically illustrates the position relationship between four separate fields of views of the four cameras of the aerial imaging system of FIGS. 1 and 2 during two consecutive flight runs;

FIG. 10 schematically illustrates the position relationship between four temporal image sequences captured along first and second runs by the four cameras of the aerial imaging system of FIGS. 1 and 2; and

FIG. 11 is a schematic front view of the airplane of FIGS. 1 and 2 during two consecutive pairs of runs illustrating the overlapping fields of view of the cameras.

### DESCRIPTION OF THE INVENTION

System Overview

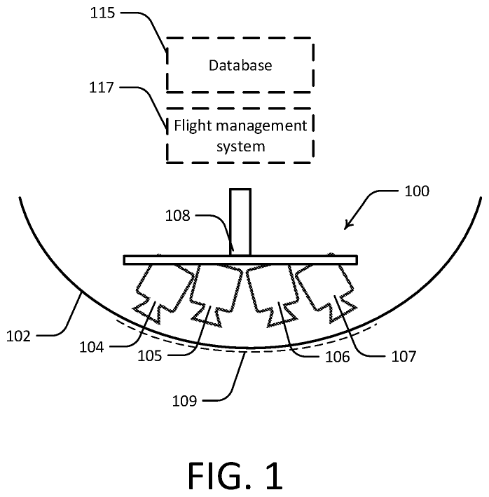

Described herein are systems and methods for performing aerial photogrammetry of a desired geographical area. Referring initially to FIG. 1, there is illustrated an aerial imaging system 100. System 100 is configured to be mounted to an underside of an aerial vehicle such as an airplane 102. Other suitable aerial vehicles upon which system 100 can be mounted include UAVs, helicopters and balloons. System 100 includes four cameras 104-107, which are mounted in operable positions on an underside of airplane 102 by a mount 108, which may be internal or external to the fuselage of airplane 102. Although four cameras are illustrated, it will be appreciated that system 100 may include other numbers of cameras, such as 2, 3, 5, 6, 7, 8, 9, 10 or greater. Typically, system 100 is mounted within an underside of airplane 102 and positioned such that the cameras' fields of view are directed through a viewing window 109 in the fuselage. However, in some embodiments, mount 108 and system 100 may extend externally of the fuselage.

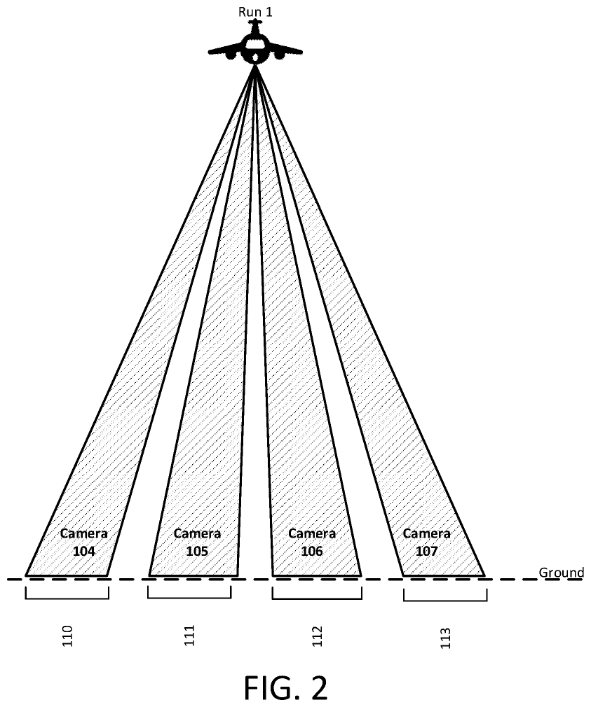

Referring now to FIG. 2, each camera is oriented at a respective downward angle in a direction transverse to a direction of flight of airplane 102 such that the cameras image separate non-overlapping fields of view 110-113 during image capture.

The angles of direction of cameras 104-107 may be selectively adjustable through manual or electromechanically controllable rotatable actuators on mount 108 (such as a gimbal mechanism). Similarly, the position of cameras 104-107 on mount 108 may be selectively adjustable using a mounting mechanism such as a rack-and-pinion mechanism. It will be appreciated that the specific geometric structure of mount 108 is variable in different embodiments. Further, in some embodiments, mount 108 is included in system 100 and sold together with cameras 104-107. In other embodiments, mount 108 is separate to system 100 and sold separately. Mount 108 may be selectively attachable to both airplane 102 and system 100 through appropriate mounting mechanisms or attachment means such as bolts/nuts or clamps.

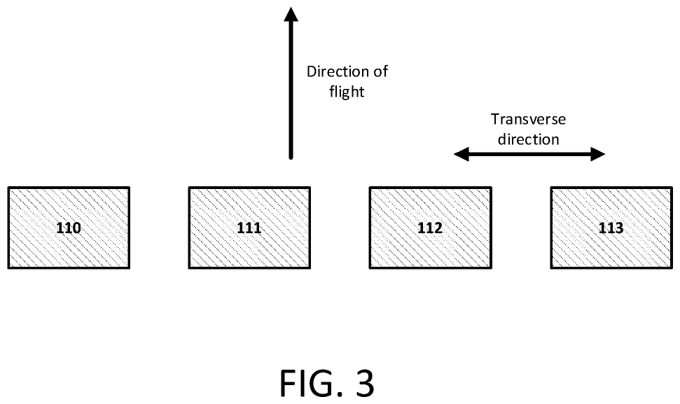

The specific orientation or angles of cameras 104-107 are defined such that the cameras image separate non-overlapping fields of view 110-113 on the ground, as illustrated in FIG. 3. Each of the cameras is typically oriented at different small off-nadir angles in the transverse direction (relative to a direction of flight of airplane 102). By way of example, cameras 104 and 107 may be oriented at transvers angles of about 21 degrees relative to nadir and cameras 105 and 106 may be oriented at transverse angles of about 7 degrees relative to nadir. Where system 100 includes an even number of cameras, such as that illustrated herein, cameras oriented at angles on opposing sides of nadir may have equal but opposite transverse angles. More broadly, the cameras may generally be oriented at transverse angles between about 5 degrees and about 25 degrees from nadir. However, smaller and greater angles than this range are also possible. In some embodiments, one camera may be oriented at nadir, particularly where the system includes an odd number of cameras.

Cameras 104-107 may be any suitable high resolution digital camera suitable for imaging at large distances. By way of example, cameras 104-107 may be A6D-100C 100 MP cameras manufactured by Hasselblad AB and having 300 mm focal length lenses. It will be appreciated that the choice of camera may be application dependent based on the desired altitude and other flight conditions of imaging.

Referring again to FIG. 1, the images captured by cameras 104-107 are stored in a local database 115 located on-board airplane 102. The images may be stored in association with metadata such as the GPS location of the images and timestamp data. System 100 may also include an associated image processing system to perform image processing as described below. However, more typically, the images captured by system 100 are downloaded and subsequently processed by a processing system separate to system 100, which is typically located on the ground.

Airplane 102 includes a flight management system 117, including a processor, which stores various parameters about the required flight path to image the desired geographic area. In some embodiments, the flight management system 117 is also responsible for storing the captured imaged. In some embodiments, flight management system 117 is operatively coupled with database 115 for storing and retrieving data.

Generating an Aerial Map (Orthomap)

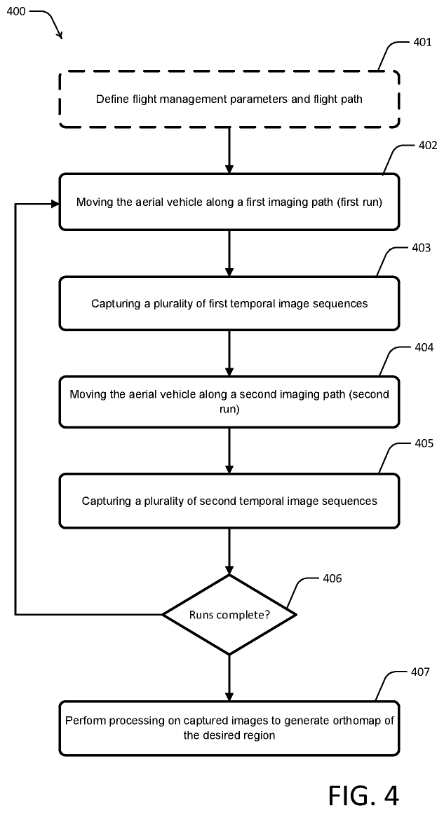

The above described aerial imaging system 100 facilitates the performing of an advantageous aerial photogrammetry process 400 which will now be described with reference to FIGS. 4-11.

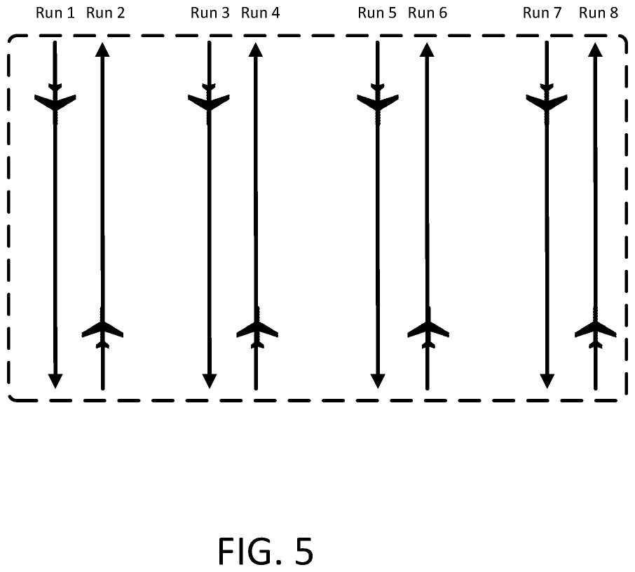

In operation, airplane 102 is controlled (remotely or by a pilot) to fly along a predefined flight path above the desired geographic area. The flight path includes a plurality of substantially linear antiparallel “runs” dispersed across the geographic area, as illustrated best in FIG. 5. The runs are divided into pairs in which overlapping imaging is performed, as described below. Preferably, the even or odd runs may be imaged in the opposite direction to reduce flight time. In this case, alternating runs are considered to be antiparallel (parallel but with opposite directions). In other embodiments, runs of a pair are imaged along the same direction in a parallel manner.

Prior to commencing a photogrammetry process, at initialization step 401, flight management system 117 is preconfigured with parameters such as:

Example flight parameters include:
Flying altitude—e.g. 10,700 feet (3,260 m).
Ground sample distance (GSD) or ground resolution—e.g. 5 cm.
Run separation of 417 metres.
Super-run separation of 2,906 metres.
Swath of two runs of 3,660 metres.
Airplane speed—e.g. 150 knots

Other possible parameters include a side and forward (temporal) overlap between frames (described below—e.g. 30%), shutter speed, image sensor ISO and aperture of the respective cameras, angles of the respective cameras and the GPS location of the flight path and individual runs.

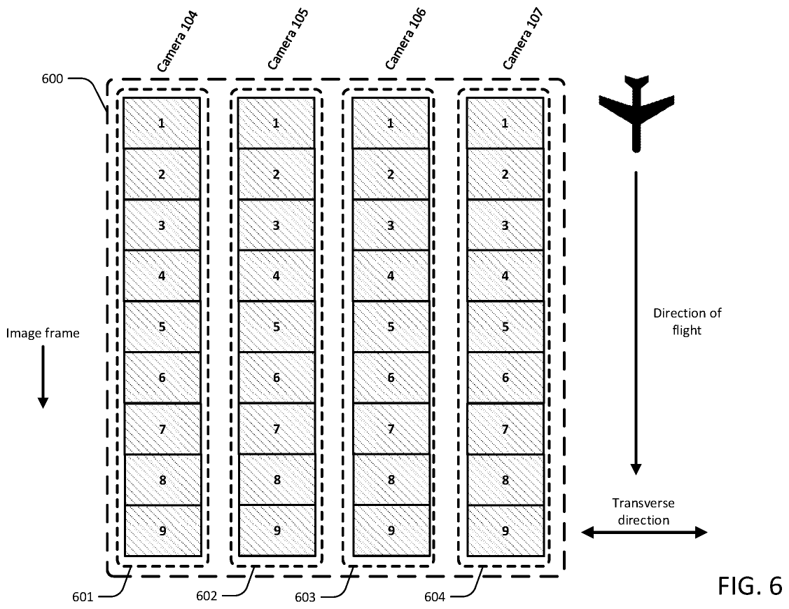

With reference to FIG. 6, at step 402, airplane 102 is controlled to move along a first imaging path 600, which is defined by a first run of the flight path. As airplane 102 moves along the first imaging path 600, at step 403, a temporal sequence of images is captured from each camera 104-107. Each temporal image sequence covers respective spatially separated regions 601-604 of an area being imaged.

The speed at which the cameras 104-107 capture images is preconfigured based on the airplane speed and altitude such that sequential images in each sequence 501-504 cover respective image regions that at least partially overlap in the forward direction. This allows the images to be subsequently stitched together to form a continuous aerial photogram or orthomap of the geographic region. The amount of forward overlap needed along the imaging path may depend on parameters such as the resolution of the cameras, the altitude of imaging and whether the images are to be used to form a digital terrain model (DTM). For the purpose of creating a DTM, the forward should be in the range of 50% to 99% of the number pixels along an image frame so that there is stereo coverage of an area for extracting terrain information. However, in some embodiments aerial maps are able to be produced with forward lap as low as 5%. This is possible where there is additional information available about the terrain, such as through LIDAR data. Thus, in various embodiments, the images of an image stream may have forward overlap of 5%, 10%, 20%, 30%, 40%, 50%, 55%, 60%, 70%, 75%, 80%, 85%, 90%, 95%, 96%, 97%, 98% or 99%.

Each region 501-504 is spatially separated such that there is a gap between adjacent regions. The width of the gap may correspond to any distance less than the width of regions 501-504 such that on a subsequent run, the fields of view of cameras 104-107 partially overlap to fill in the gaps. This process is described below.

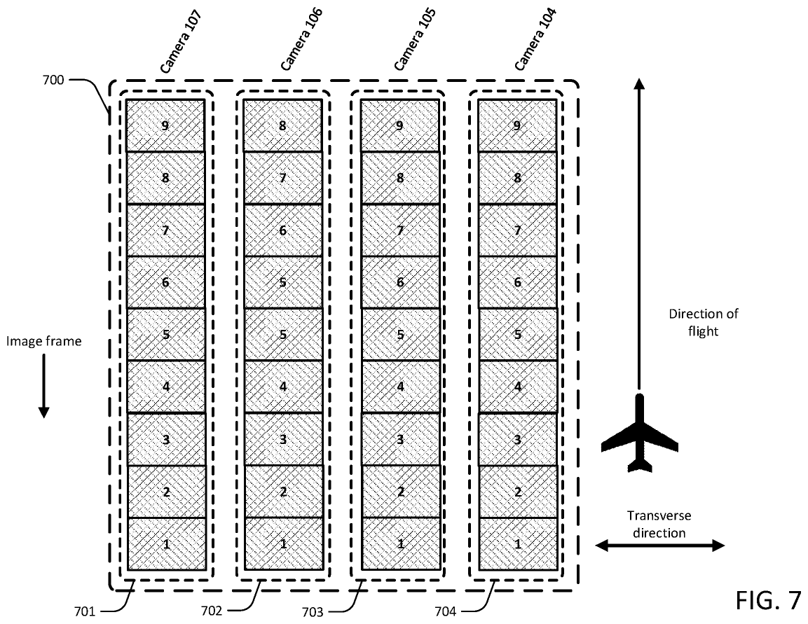

Referring now to FIG. 7, at step 404, airplane 102 is controlled to move along a second imaging path 700, which is defined by a second run of the flight path. As airplane 102 moves along the second imaging path 700, at step 405, a temporal sequence of images is captured from each camera 104-107. Each temporal image sequence covers respective spatially separated regions 701-704 of an area being imaged.

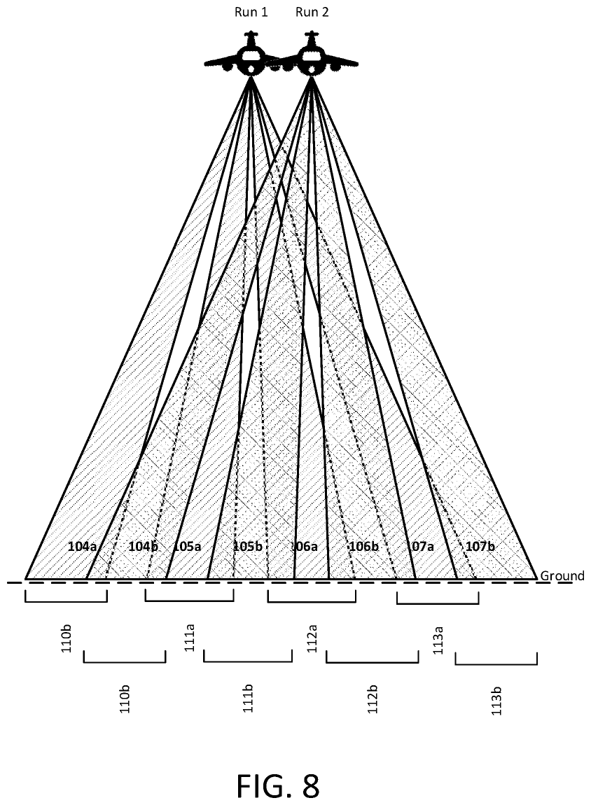

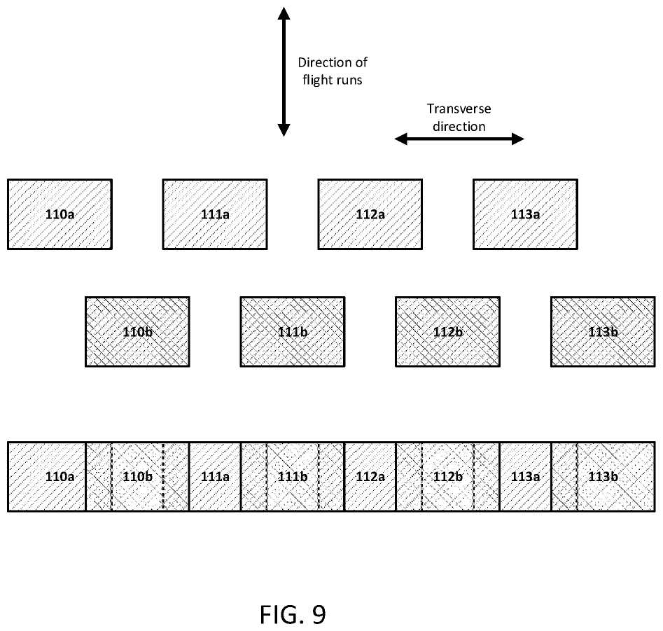

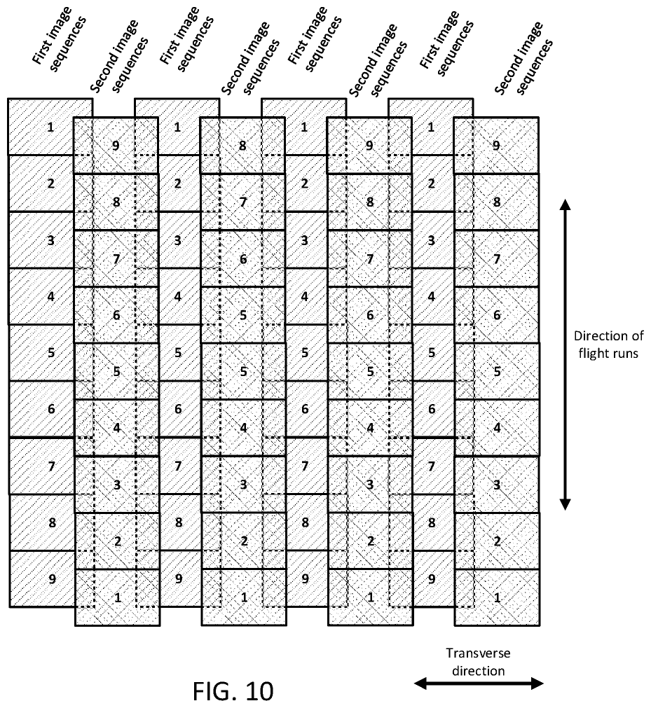

The position of the second imaging path 700 is defined relative to the first imaging path 600 such the fields of view of each of cameras 104-107 partially overlap with at least one of the fields of view of the respective cameras 104-107 along the first imaging path 600. This relative positioning is illustrated in FIGS. 8 and 9. This operation provides that there is partial overlap between the first and second spatially separated regions of the area being imaged. The resulting image coverage of the two flight runs is illustrated in FIG. 10.

In the illustrated embodiment, the first and second imaging paths are defined such that the first spatially separated regions partially overlap with the second spatially separated regions captured by the same camera. This is due to the fact that the airplane 102 performs parallel flight runs. However, it will be appreciated that the overlap need not occur between the field of view of the same camera. For example, where successive flight runs are antiparallel (parallel but with opposite direction), the field of view of camera 104 overlaps with the field of view of camera 107 on the next run. Similarly, the field of view of camera 105 would overlap with the field of view of camera 106 on the next run.

The degree of overlap between the first and second spatially separated regions of the area being imaged is preferably in the range of 5% to 50% but may be greater or less than this. In some embodiments, the degree of overlap between the first and second spatially separated regions of the area being imaged is 5%, 6%, 7%, 8%, 9%, 10%, 15%, 20%, 25%, 30%, 35%, 40%, 45% or 50%. Some degree of overlap is required so that, during a subsequent image processing process, pattern matching can be used to stitch the overlapping images together. However, a large degree of overlap will reduce the overall coverage of the flight runs.

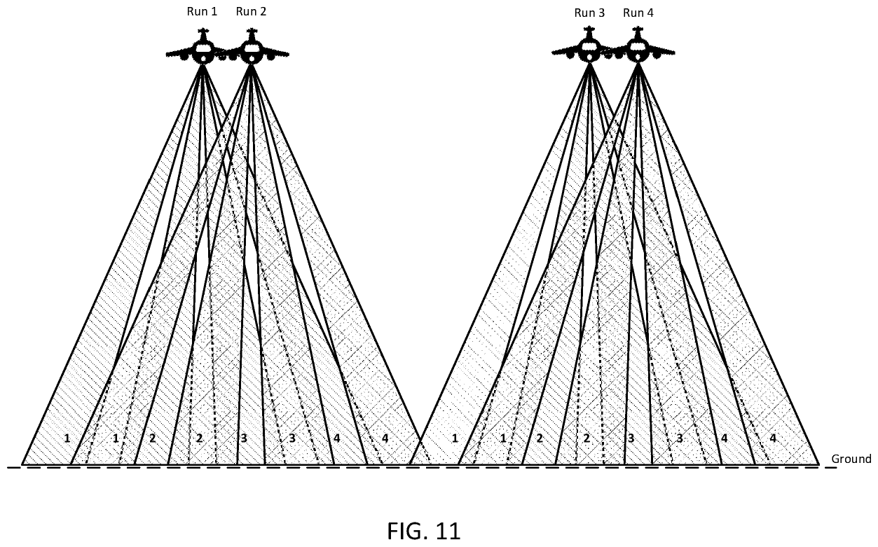

The images captured during steps 403 and 405 are stored in database 115 in real-time or near real-time with appropriate buffering. Subsequent pairs of flight runs are performed on adjacent areas. As illustrated in FIG. 11, flight runs within a pair are significantly closer than flight runs between adjacent pairs. This is because different flight runs do not need each camera's field of view to partially overlap in an interleaving manner. Separate flight runs simply require one camera's field of view to partially overlap so that continuous coverage of the geographical area can be imaged. By way of example, the distance between runs of a pair may be in the order of 400 metres while the distance between run pairs (super-run separation) may be in the order of 3,000 metres.

The pairs of flight runs outlined in steps 402-405 are repeated until, at step 406, all runs are deemed to be complete. At step 407, image processing is performed on the images from the first and second temporal image sequences of each pair of flight runs to generate an aerial map of the geographical area being imaged. The image processing of step 407 may be performed on-board airplane 102 by the processor of flight management system 117 or downloaded to a separate system for processing. In some embodiments, some pre-processing steps may be performed by the processor of flight management system 117 while the main processing is performed by the separate processor.

In some embodiments, the image processing of step 407 may commence before all of the images of the geographical area are obtained. For example, the image processing may occur after each run pair is completed. This image processing may include conventional processing steps such as:
Determining the relative positions of the images in the first and second temporal image sequences.
Stitching the images together based on common features identified in the partial overlap regions of the images to generate an aerial map of the area.
Stitching multiple aerial maps (orthomaps) together to form an ortho-mosaic.
Data format conversion (e.g. from raw to .JPEG or .TIF formats).
Backing up data.
Colour balancing.
Aero triangulation.
Generation of a DTM from images.

The above process 400 is advantageous as every overlapping frame is now captured from a different location and therefore has intersecting rays of light with each measurement. This significantly simplifies the mathematical problem of combining the constituent images into an aerial map. Furthermore, the captured images may be run through standard photogrammetric packages without redesigning the processing engine.

In addition, the use of system 100 to perform method 400 allows for more efficiently imaging a geographical area when compared to the known prior art systems.

Example parameters from a project using method 400 are included below:
Geographical area being imaged—2,000 km².
Dimensions—50 km length×40 km width.
Required runs—7×2 runs (14 runs total).
Airplane speed—150 knots ground speed (277 km/h)
Turn time—3 minutes.
Total time—193 minutes (3 hours 13 minutes)
Data obtained—4.45 TB of Raw Imagery.

It will be appreciated that, although the flight path described above requires consecutive runs of a flight path to define flight pairs of interleaved fields of view, this is not necessary. With appropriate image processing, non-adjacent runs of the flight path may be performed consecutively and intermediate gaps later filled in.

The invention also extends to an aerial map of an area generated by method 400.

Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. An aerial imaging system including a plurality of cameras configured to be mounted in operable positions on an underside of an aerial vehicle, each camera being oriented at a respective angle in a direction transverse to a direction of flight of the aerial vehicle such that the cameras image separate non-overlapping fields of view during image capture.

2. The system according to claim 1 wherein each of the cameras are oriented at off-nadir angles.

3. The system according to claim 1 including an even number of cameras.

4. The system according to claim 3 wherein the cameras are oriented at angles between 5 degrees and 25 degrees from nadir.

5. The system according to claim 1 including four cameras.

6. The system according to claim 1 including an odd number of cameras.

7. The system according to claim 6 wherein one of the cameras is oriented nadir.

8. A method of performing aerial photogrammetry using an aerial imaging system having a plurality of cameras configured to be mounted in an operable position on an underside of an aerial vehicle and oriented such that, in operation, the cameras image separate non-overlapping fields of view, the method including the steps:
i. moving the aerial vehicle along a first imaging path and capturing a plurality of first temporal image sequences, each of the first temporal image sequences corresponding to a sequence of images captured from a respective one of the plurality of cameras and covering respective first spatially separated regions of an area being imaged;
ii. moving the aerial vehicle along a second imaging path and capturing a plurality of second temporal image sequences, each of the second temporal image sequences corresponding to a sequence of images captured from a respective one of the plurality of cameras and covering respective second spatially separated regions of the area being imaged;
wherein the second imaging path is defined such that the fields of view of each of the cameras partially overlap with at least one of the fields of view of a camera along the first imaging path thereby to provide partial overlap between the first and second spatially separated regions of the area being imaged.

9. The method according to claim 8 wherein the first and second imaging paths are defined such that the first spatially separated regions partially overlap with the second spatially separated regions captured by the same camera.

10. The method according to claim 8 wherein the second imaging path is substantially parallel or antiparallel to the first imaging path and shifted laterally relative to a direction of flight of the aerial vehicle.

11. The method according to claim 8 wherein the overlap between the first and second spatially separated regions of the area being imaged is in the range of 5% to 50%.

12. The method according to claim 11 wherein the overlap between the first and second spatially separated regions of the area being imaged is 30%.

13. The method according to claim 8 including the step of performing image processing on the images from the first and second temporal image sequences to generate an aerial map of the area being imaged.

14. The method according to claim 8 wherein the first and second imaging paths correspond to consecutive runs of a flight path over the area being imaged.

15. The method according to claim 8 wherein the first and second imaging paths correspond to a same direction of travel of the aerial vehicle.

16. The method according to claim 8 wherein the first and second imaging paths correspond to an opposite direction of travel of the aerial vehicle.

17. A method of generating an aerial map of an area from the first and second temporal image sequences produced by the method of claim 8, the method including the steps of:
i. determining the relative positions of the images in the first and second temporal image sequences; and
ii. stitching the images together based on common features identified in the partial overlap regions of the images to generate an aerial map of the area.

18. An aerial map of an area generated by a method according to claim 8.
